(19) United States
(12) Patent Application Publication
(10) Pub. No.: US 2026/0360240 A1
(43) Pub. Date: Nov. 12, 2026

(54) ONE-PIECE ELECTRONIC ARTICLE SURVEILLANCE AND SECURITY DEVICES

(71) Applicant: All-Tag Corporation, Boca Raton, FL (US)

(72) Inventor: Alain FAVIER, Mexico (MX)

(73) Assignee: All-Tag Corporation, Boca Raton, FL (US)

(21) Appl. No.: 19/644,177

(22) Filed: Apr. 10, 2026

Related U.S. Application Data
(60) Provisional application No. 63/801,483, filed on May 7, 2025.

(51) Int. Cl. G08B 13/24

(52) U.S. Cl. CPC G08B 13/2434

(57) ABSTRACT

A one-piece EAS device is disclosed having an actuator with a handle. The handle aids in the removal of the device, including when the actuator is jammed.

### RELATED APPLICATION

This application claims the benefit of U.S. Provisional Application Ser. No. 63/801,483, filed May 7, 2025, entitled “One-Piece Electronic Article Surveillance And Security Devices,” which is incorporated herein by reference in its entirety.

### FIELD OF THE INVENTION

The present invention relates to electronic article surveillance (“EAS”) devices and security devices. More particularly, the invention relates to an improved one-piece hard tag (“One-Piece Tag”) to be fastened to products such as, but not limited to, high theft and/or high value clothing articles and accessories.

### BACKGROUND OF THE INVENTION

EAS hard tags and pins (“Tags”) are generally known in the art, including as disclosed, for example, in U.S. Pat. No. 5,022,244 which is incorporated herein by reference. Since the advent of Tags in the 1970's, retailers have applied millions of these Tags to soft goods and some hard goods to prevent shoplifting. In the early days the Tags consisted of two main parts: (a) a body generally made of plastic that included a locking and unlocking mechanism used in conjunction with (b) a metal pin with a plastic or metal head that would go through an article of clothing to be either in a locked (protected) or unlocked position (pin released from locking mechanism). Tags have had as a major inconvenience the fact that store operators need to handle and keep track of two separate parts after unlocking (detaching) a Tag from clothes. Pins are often lost and can cause an injury as they may wound store employes or customers. To overcome this challenge, One-Piece Tags were introduced in the twenty-first century as disclosed, for example, in U.S. Pat. Nos. 10,676,968 and 11,761,247 and China Patent No. 207063739 which are incorporated herein by reference. These One-Piece Tags incorporate in one piece the body with the locking and unlocking means and the pin. These One-Piece Tags have proven to be a very effective, safe and a practical way of combating shoplifting of soft goods such as, but not limited to, clothing and clothing accessories. However, these Tags still present several challenges and drawbacks such as but no limited to:
1. One-Piece Tags are difficult to release/remove/detach when fastened to thick and/or dense layers of fabric such as, but not limited to, the waist band of jeans where the denim layer is doubled as the pull-out force needed to fully release the spring loaded telescopic/travelling actuator that allows the pin to travel from a locked to an unlocked position surpasses the value of the spring thus becoming jammed in a position where the checkout clerk cannot remove the protected article from the One-Piece Tag although the locking mechanism holding the pin is no longer engaged. As the top of the telescopic/travelling actuator is in a flush position with the top of the One-Piece Tag when locked, it gives no surface to be gripped by the checkout clerks to help the spring loaded telescopic/travelling actuator travel to the fully unlocked position to remove the protected article from the One-Piece Tag.
2. One-Piece Tags are difficult to release at the checkout point when fastened to, but not limited to, blister packs of, for example, batteries, ink cartridges, USB drives, and computer accessories, as the pull-out force needed to fully release the spring loaded telescopic/travelling actuator that allows the pin to travel from a locked to an unlocked position surpasses the value of the spring thus becoming jammed in a position where the checkout clerk cannot remove the protected article from the One-Piece Tag although the locking mechanism holding the pin is no longer engaged. As the top of the telescopic/travelling actuator is in a flush position with the top of the One-Piece Tag when locked, it gives no surface to be gripped by the checkout clerks to help the spring loaded telescopic/travelling actuator travel to the fully unlocked position to remove the protected article from the One-Piece Tag.
3. One-Piece Tags with a fixed angle that opposes the telescopic/travelling system are very difficult to release/remove/detach when the store operator applies excessive force on the telescopic/travelling system that incorporates the pin which creates a lever spring load effect originating from the fixed angle pulling the pin upwards which pulls the magnetic ball-bearings from the locking mechanism upward in the V-shaped inverted cup. The more the store operator applies force, the more lever effect it will create on the ball-bearings which can lead to a critical point where the magnetic pull force from the magnetic detachers at the checkouts will no longer suffice to pull the ball-bearings down to release the pin and permit the full travel of the pin from the locked to the unlocked position.
4. One-Piece Tags with a fixed angle that opposes the telescopic/travelling system when protecting in the locked position, for example a garment or a plastic blister, present the challenge of leaving a fraction of the metal pin that travelled from the unlocked to the locked position exposed to shoplifters which can cut the pin with small pliers freeing the secured product.
5. One-Piece Tags in general, in the locked position, tend to damage the garment's fabric with the pin that traversed the garment when going from the unlocked to locked position using the telescopic/travelling system. The damage happens as the total weight of the One-Piece Tag rests solely on the pin that traversed the fabric. When store personnel and/or customers place/fold/try-on protected garments with One-Piece Tags the balancing movements of the One-Piece Tag which rests solely on the pin will mechanically drill/enlarge the hole made by the pin when it traverses the fabric. Such hole which initially is of about 1.2 mm (diameter of the pin that traversed the fabric) can easily reach 2 to 5 mm which can result in customers refusing to purchase garments with large holes. This problem forces store personnel to imperatively position the One-Piece Tags in order to have the needle traverse the seems of clothing which is a major limitation and is time consuming.
6. One-Piece Tags cannot protect very sensitive fabrics such as ties, leather scarves, silk shirts as the pin that traverses them plus the drilling/enlargement effect described in point 5 will generate enough damage when these products are handled by store personnel and/or customers which can result in customers refusing to purchase a garment with a large hole.
7. In opposition to two piece tags where it is very easy to align and traverse a seam of a garment with the pin, when using a One-Piece Tag the pin is hidden in the unlocked position within the telescopic travelling actuator. If a store personnel presses the actuator half way, the head of the pin will still be partially hidden by the body of the One-Piece Tag making it very difficult to align the pin with a chosen seam and traverse it. On many occasions the pin will not traverse the seam because of the lack of visibility which with the drawback explained in point 6 which will cause irreparable damage to sensitive fabrics resulting in customers refusing to purchase a damaged garment.

In summary: One-Piece Tags are a good solution to combat shoplifting but present drawbacks affecting the shoppers purchasing experience, often causing frustration to check-out clerks who lose time and battle with One-Piece Tags while attempting to position and remove them from clothes comprised of thick fabrics such as denim jeans and, but not limited to, blister packs generally made of plastic and/or cardboard and clothes made of sensitive fabrics such as silk and cotton. These and other shortcomings of these known One-Piece Tags are addressed by the present invention.

### SUMMARY OF THE INVENTION

To solve the above challenges with current One-Piece Tags, the invention is directed to an improved One-Piece-Tag with an enhanced release mechanism, a weight dispersion system to protect garments made of sensitive fabrics, guiding edges to allow store personnel to easily align the pin with the seams of a garment and, an enhanced clamping system preventing shoplifters from accessing the pin with, for example, pliers while in the engaged/locked position on a garment or product. The improved One-Piece Tags are generally made of a plastic shell with an upper part and a bottom part whereas one of these two parts is more flexible than the other that incorporates (a) known EAS ferrites or labels including RF and/or acousto-magnetic labels such as manufactured or sold by All-Tag Corporation and Sensormatic, a division of Johnson Controls; and/or RFID (radio frequency indentification) label inlays manufactured or sold by Avery Denison; (b) a locking and unlocking mechanism; (c) a pin housed inside a telescopic and/or travelling actuator that travels from a starting unlocked position to an opposite locked position having passed through an article of clothing or through packages/blisters containing high theft products such as batteries, memory sticks among others; (d) a handle/surface protruding from the telescopic and/or travelling actuator accessible to the checkout clerks to manually assist the pin when jammed by thick fabrics or dense materials to travel from the locked to the fully unlocked position at the checkout; (e) optionally a weight dispersion system around the pin to prevent the pin from damaging garments; and (f) optionally guiding edges to allow store personnel to properly align the pin with the seam of a garment. The invention provides for the quick and easy release of One-Piece Tags from an article at checkout, a weight dispersion system surrounding the pin to avoid damaging garments with the pin traversing them and allowing an easy alignment of the pin with the seam of a garment.

A primary object of the present invention is to provide an improved One-Piece Tag that will always and easily release at retail checkouts, that will not damage sensitive fabrics, that will allow an easier and faster alignment of the pin with the seam of a garment and, will prevent a shoplifter from having access to the pin to cut it while in the locked position and remove the Tag. The One-Piece Tag of the present invention is intended to include:
1. A U-shaped housing generally made of plastic such as PVC. The U-shaped housing may include two arms, one of which is more flexible than the other.
2. At least one resonant RF and/or AM EAS label or ferrite and/or and RFID inlay.
3. A locking and unlocking mechanism to prevent the unauthorized removal of the One-Piece Tag by a shoplifter and the removal at the checkout point.
4. A spring-loaded telescopic travelling actuator that includes a pin that goes through fabrics or plastic/cardboard blisters into and out of the locking mechanism.
5. A handle attached to the spring-loaded telescopic travelling actuator to (a) allow the checkout clerk to manually assist the spring-loaded telescopic travelling actuator to travel from the locked to the fully unlocked position at the checkout to allow the removal of protected goods from the One-Piece Tag by pulling upward on the handle, (b) allow a change of angle of the spring-loaded telescopic travelling actuator when it becomes jammed inside the locking mechanism to allow the spring-loaded telescopic travelling actuator to travel from a locked to a fully unlocked position at the checkout allowing the removal of protected goods from the One-Piece Tag by disengaging at least one of the ball-bearings by the change of angle.
6. A weight dispersion device surrounding the pin that will prevent the weight of the One-Piece Tag to solely rest on the pin. It will assist in distributing the weight of the One-Piece Tag on a much larger surface to prevent the pin from damaging sensitive fabrics while customers and/or store personnel handle protected garments with the One-Piece Tag.
7. Guiding edges to allow store personnel to easily align the pin with the seam of a garment.

These primary and other objects of the invention will be apparent from the following description of the preferred embodiments of the invention and from the accompanying drawings.

### BRIEF DESCRIPTION OF THE DRAWINGS

The following detailed description of the specific non-limiting embodiments of the present invention can be best understood when read in conjunction with the following drawings, where like structures are indicated by like reference numbers.

Referring to the drawings:

FIG. 1A is a front, side, top and bottom view of a current art One-Piece Tag.

FIG. 1B is a sectional side view of a current art One-Piece Tag in the unlocked position with an AM ferrite, a locking/unlocking mechanism, a spring-loaded telescopic travelling actuator and a pin.

FIGS. 1C-1D are the current art One-Piece Tag being affixed to a shirt made of thin non-dense fabric.

FIG. 1E is a sectional side view of a current art One-Piece Tag in the locked position wherein the pin went through thin not dense fabric such as the fabric of a cotton shirt. The thin not dense fabric causes little pressure around the pin as seen in pressure lines. The top of the spring-loaded telescopic travelling actuator is seen completely flush with the top of the Tag.

FIG. 1F is a sectional side view of a current art One-Piece Tag in the unlocked position wherein the spring-loaded telescopic travelling actuator and pin automatically went from the locked to the unlocked position when the magnetic field of the magnetic detacher pulled down the magnetic ball-bearings.

FIGS. 2A-2B represent the current art One-Piece Tag being affixed to the waistband of a denim jean.

FIG. 2C is a sectional side view of a current art One-Piece Tag in the locked position wherein the pin went through the thick and dense fabric of the waistband on a denim jean. It shows the thick and dense fabric applying considerable pressure around the pin. The top of the spring-loaded telescopic travelling actuator is seen completely flush with the top of the Tag.

FIG. 2D is a sectional side view of a current art One-Piece Tag on a magnetic detacher wherein the ball-bearings of the magnetic lock are no longer holding the pin, wherein the spring-loaded telescopic travelling actuator and a pin are jammed by the thick denim fabric in the locked position. The top of the spring-loaded telescopic travelling actuator is seen completely flush with the top of the One-Piece Tag meaning that the operator cannot assist in raising the spring-loaded telescopic travelling actuator up to the fully unlocked position.

FIG. 3A is a front, side, top and bottom view of the improved One-Piece Tag of the invention.

FIGS. 3B-3C show the improved One-Piece Tag of FIG. 3A being affixed to the waistband of a denim jean.

FIG. 3D is a sectional side view of the improved One-Piece Tag of FIG. 3A in the waistband of a denim jean sitting on a magnetic detacher at a store checkout. As the pin of the spring-loaded telescopic actuator was jammed in the locked position by the thick denim; the store clerk uses the handle to assist the spring-loaded telescopic actuator in going from the fully down to the fully up position as the ball-bearings have been attracted by the magnetic detacher thus not retaining the pin.

FIG. 4A is a sectional side view of the improved One-Piece Tag of FIG. 3A protecting a thin fabric shirt to which extreme force was applied to the spring-loaded telescopic actuator during positioning which generated a lever spring-load effect that originated from the fixed angle pulling the pin upwards which pulls the magnetic ball-bearings from the locking mechanism upwards into the V-shaped inverted cup jamming the pin and by consequence the spring-loaded telescopic actuator preventing the release of the shirt even if the store clerk pulls upward on the handle.

FIGS. 4B-4E are a sectional side view of the improved One-Piece Tag of FIG. 4A sitting on a magnetic detacher. It depicts a store clerk applying pressure to one of the edges of the handle to slightly change the angle of the pin which will release at least one of the ball-bearings that will consequently allow the magnetic force of the magnetic detacher to pull all ball-bearings to free the pin which consequently will allow the telescopic actuator to pop-up either by itself if the protected item did not apply too much pressure on the pin or by pulling upwards on the handle in case the pin went through thick fabric such as denim from a waste-band of a jean.

FIG. 5A is a side view of a current One-Piece Tag protecting a garment.

FIGS. 6A-6F are side views of an improved One-Piece Tag variant in the open and the engaged positions.

FIG. 7A is fractional zoom view from the area where the pin, a piece of garment, the upper and lower parts of a current One-Piece Tag meet.

FIG. 7B show the current One-Piece Tag in position on a tie showing how the forces F generated by the weight of the One-Piece tag concentrate around the pin.

FIG. 7C is fractional zoom view from the area where the pin, a piece of garment the upper and lower parts of an improved variant One-Piece Tag meet.

FIG. 7D shows the improved variant One-Piece Tag in position on a tie showing how the forces F generated by the weight of the One-Piece tag are dispersed around the weight dispersion receiving areas.

FIG. 8A show how the weight dispersion receiving areas can be of different sizes

FIGS. 9A-9C show and improved One-Piece Tag variant with guiding edges/marks that help align the pin with the seam of a pair of pants.

### DETAILED DESCRIPTION OF THE PREFERRED EMBODIMENTS

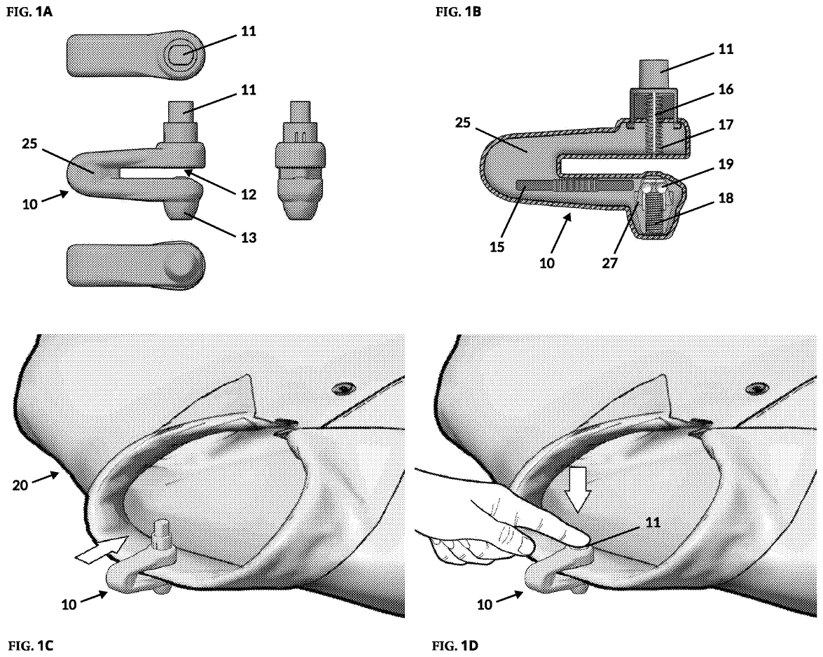

Referring to FIG. 1A, there is shown a current art One-Piece Tag 10 in a front, side, top and bottom views comprising a spring-loaded telescopic actuator 11, a protection area 12 where items to be secured are inserted, a fixed angle side 25 and the area 13 where the locking and unlocking mechanism is housed.

Referring to FIG. 1B, there is shown on a current art One-Piece Tag 10 in an unlocked position, an EAS RF ferrite 15, the spring-loaded telescopic actuator 11, the spring of the actuator 17, the pin 16 that goes through items to be protected, the ball-bearings 19 from the locking mechanism and spring 18 from the locking mechanism that maintain the ball-bearings in an upward position inside the inverted V-shape cup 27.

Referring to FIGS. 1C-1D, there is shown the current art One-Piece Tag 10 positioned on the collar of a shirt 20 and the actuator 11 being pushed onto the locked position.

Referring to FIG. 1E, there is shown the current art One-Piece Tag 10 in the locked position wherein the pin 16 went through the fabric of the collar of a shirt 20. There is depicted small pressure forces 26 surrounding the pin 16 as the fabric of shirt 20 is thin and not very dense.

Referring to FIG. 1F, there is shown the current art One-Piece Tag 10 sitting on top of a magnetic detacher 30 which has pulled down the ball-bearings 19 which compressed the spring 18 and released spring 17 which brought the spring-loaded telescopic actuator 11 up to its fully unlocked position freeing the shirt 20. Forces 26 were not strong enough to retain the pin 16 in its locked position.

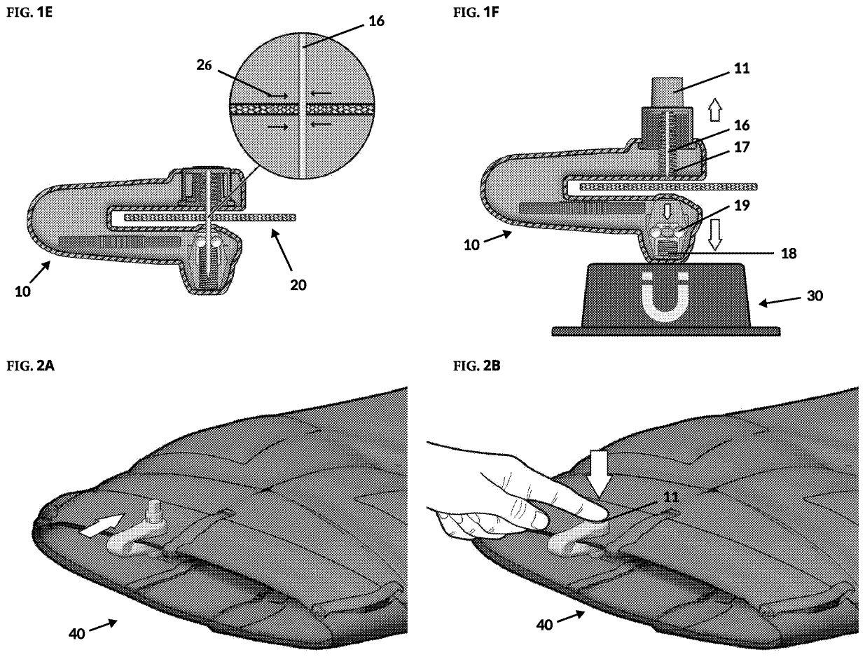

Referring to FIGS. 2A-2B, there is shown the current art One-Piece Tag 10 positioned on the waistband of a denim jean 40 and the actuator 11 being pushed onto the locked position.

Referring to FIG. 2C, there is shown the current art One-Piece Tag 10 in the locked position wherein the pin 16 went through the fabric of the waistband of a denim jean. There is depicted the strong pressure forces 26′ surrounding the pin 16 as the fabric of the denim jean 40 is thick and dense.

Referring to FIG. 2D, there is shown the current art One-Piece Tag 10 sitting on top of a magnetic detacher 30 which pulled down the ball-bearings 19 which compressed the spring 18. However, the pressure forces 26′ around pin 16 are so strong that spring 17 is not able to pop-up the spring-loaded telescopic actuator 11 and jamming the pin 16 in the locked position. This prevents the jean 40 from being released after being paid, thereby causing frustration to the checkout clerk and affecting the shopping experience of the customer.

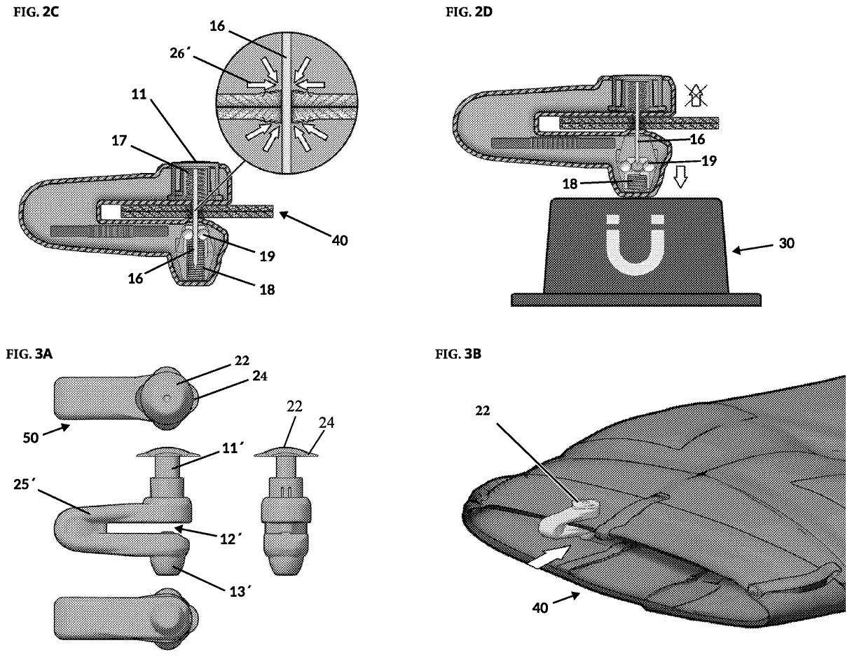

Referring to FIG. 3A, there is shown the enhanced One-Piece Tag 50 in a front, side, top and bottom views comprising a spring-loaded telescopic actuator 11′, a handle 22 with its edges 24, a protection area 12′ where items to be secure are inserted, a fixed angle side 25′ and the area where the locking and unlocking mechanism is housed 13′.

Referring to FIGS. 3B-3C, there is shown the enhanced One-Piece Tag 50 positioned on the waistband of a jean 40 and the actuator 11′ being pushed onto the locked position by using handle 22.

Referring to FIG. 3D, there is shown the enhanced One-Piece Tag 50 sitting on top of a magnetic detacher 30 which by magnetic force has pulled down the ball-bearings 19′ which compressed the spring 18′. As the pressure forces 26′ surrounding pin 16 are so strong, the spring 17′ cannot automatically pop-up the spring-loaded telescopic actuator 11′. It is shown how using the handle 22 the checkout clerk can quickly and easily help the spring-loaded telescopic actuator 11 reach its fully upward position to release the jean 40.

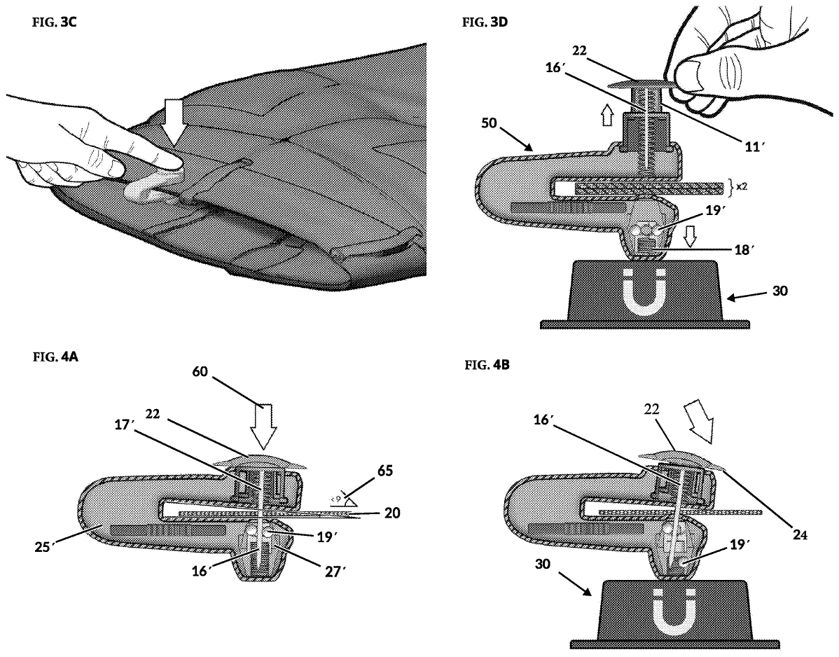

Referring to FIG. 4A, there is shown the enhanced One-Piece Tag 50 onto which excess force 60 was applied onto handle 22 which by spring-load lever effect from angle 25′ created a 9 degree angle 65 which causes a strong pull-up pressure on pin 16′ which consequently generates a pull-up force on ball-bearings 19′ which generate an extreme retaining force on pin 16′ as the ball-bearing are pulled up into the V-shaped inverted cup 27′ completely jamming the enhanced One-Piece Tag in the locked position preventing the store clerk removing the article 20 no matter if its composed of a thin or thick layer even by exerting an upward force on the handle 22.

Referring to FIGS. 4B-4E, there is shown the enhanced One-Piece Tag 50 from FIG. 4A with its jammed pin 16′ sitting on top of magnetic detacher 30 whereas the checkout clerk applies pressure on edge 24 of handle 22 to slightly change the angle of pin 16′ which will help release at least one ball-bearing 19′ followed by the rest as the magnetic detacher is exerting a downward magnetic pull force. Once all ball-bearings are released as shown in FIG. 4D, the spring 17′ will pop-up the spring-loaded telescopic actuator 11′ to its full-up position to release jean 40 as seen on FIG. 4E.

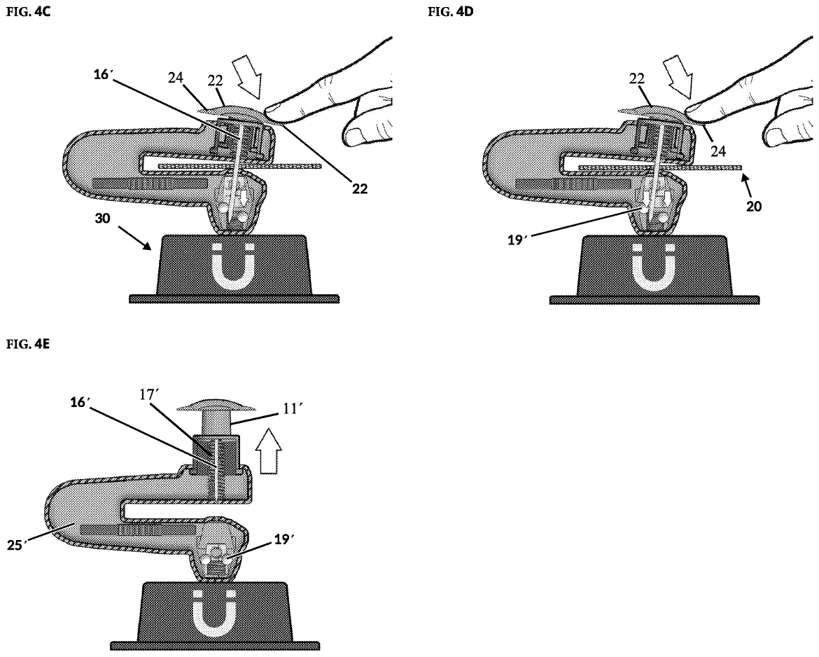

Referring to FIG. 5A, there is shown an enhanced One-Piece Tag 50 with a rigid upper arm 44 and a rigid lower arm 43 in the engaged position protecting a shirt 20 showing a gap 12 in the protection area where the pin 16′ is accessible to a shoplifter to be cut with small pliers.

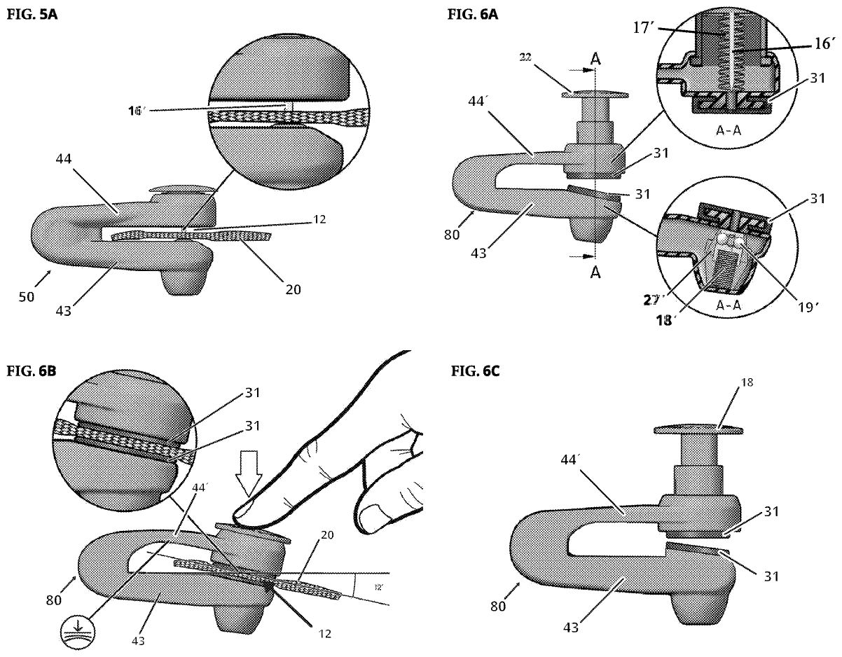

Referring to FIGS. 6A-6F there is shown the enhanced variant One-Piece Tag 80 with a flexible upper arm 44′ and rigid lower arm 43, with the upper flexible arm 44′ in the unengaged position in FIGS. 6A, 6C and 6E and depicting the weight dispersion receiving areas 31 in different but not limitative angles which when matching will totally cancel the gap in the protection area 12 thus preventing the access to the pin 16 to a shoplifter when the One-Piece Tag is engaged protecting a garment 20 in FIGS. 6B, 6D and 6F. The receiving areas 31 incorporate flexible cushion pads made of rubber or foam among others that have two main functions: (a) smoothly distribute the weight of the enhanced One-Piece Tag over their surface to protect sensitive fabrics instead of distributing the weight solely on the pin as done in the prior art One-piece Tags, and (b) compensating the tolerance magnetic locks composed of ballbearings 19′, a spring 18′ and inverted V shaped cups 27′ have when fully engaged using the telescopic travelling actuator as they never lock the needle 16′ in a specific position often springing back open from 0.5 to 2.5 mm which leaves a gap big enough for a shoplifter to access the pin 16′.

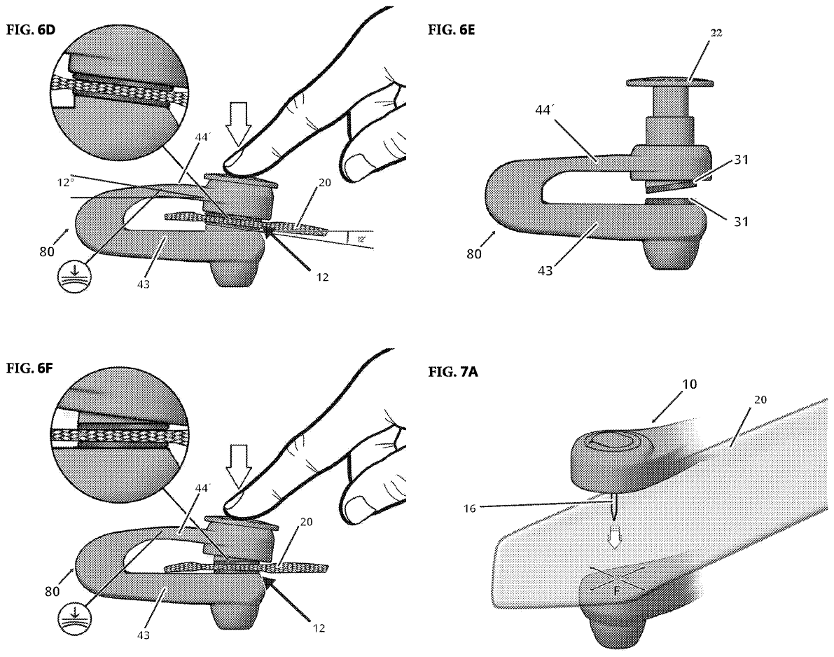

Referring to FIGS. 7A and 7B there is shown in FIG. 7A the pin 16 from a prior art One-Piece tag 10 about to traverse a tie 20 making a hole of the diameter of the pin 16 (of around 1 to 1.2 mm) depicting in FIG. 7B how the forces exerted on the hole by the weight of the prior art One-Piece Tag 10 concentrate solely around the pin 16.

Referring to FIGS. 7C and 7D there is shown in FIG. 7C the pin 16′ from an enhanced variant One-Piece tag 80 about to traverse a tie 20 making a hole on of the diameter of the pin 16 (of around 1 to 1.2 mm) depicting in FIG. 7D how the forces exerted on the hole by the weight of the enhanced variant One-Piece Tag 80 are dispersed all around the weight receiving areas of cushion pads 31 preventing the pin 16′ from damaging the fabric.

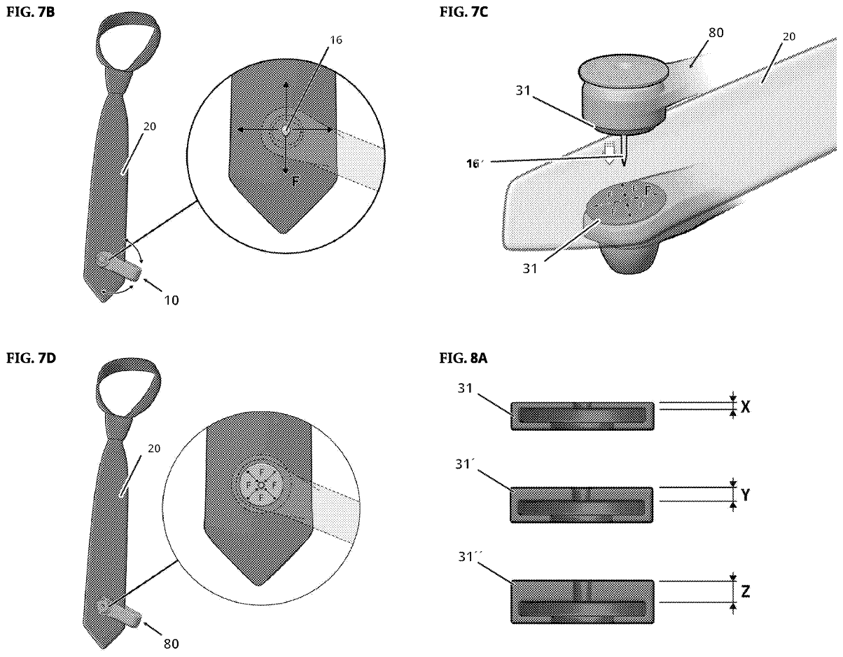

Referring to FIG. 8A there is shown the cushion pads 31, 31′ and 31′′ in different sizes in order to match the different thicknesses of garments or products to be protected.

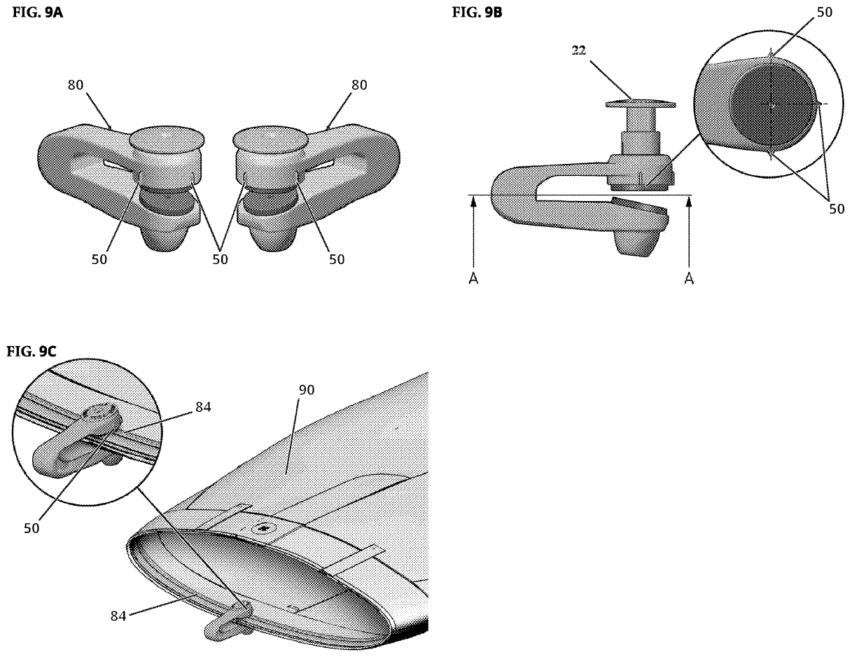

Referring to FIGS. 9A-9C there is shown side views of an enhanced variant One-Piece Tag 80 having guides 50 protruding outwardly for the One-Piece Tag 80. The guides 50 aid store operators align the seam 84 of a pair of pants 90 before engaging the actuator handle 22 to make sure the pin 16′ will traverse the seam and not the fabric which may cause damage to the fabric.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. As will be apparent to one skilled in the art, various modifications can be made within the scope of the aforesaid description. Such modifications being within the ability of one skilled in the art form a part of the present invention and are embraced by the appended claims.

1. A one-piece electronic article surveillance (“EAS”) tag comprising a housing having an upper arm and a lower arm, the housing includes an EAS ferrite and/or an RFID label, the upper arm including a spring-loaded telescopic actuator and a pin, the lower arm including a locking mechanism for receiving and locking the pin, an opening between the upper arm and the lower arm for receiving an article through which the pin traverses to hold the article, wherein the improvement comprises a handle on the top of the actuator adapted to be engaged by an operator to remove the pin from the article when the pin is unlocked but jammed in the article.

2. The one-piece EAS tag of claim 1 wherein the handle includes an outer edge.

3. The one-piece EAS tag of claim 1 wherein the upper arm is flexible.

4. The one-piece EAS tag of claim 3 wherein the upper arm includes a first receiving area for receiving the article and the lower arm includes a second receiving area for receiving the article, wherein the first and second receiving areas are configured to engage the article such that the pin is not exposed.

5. The one-piece EAS tag of claim 4 wherein the first and second receiving areas include flexible cushion pads.

6. The one-piece EAS tag of claim 5 wherein the flexible cushion pads are made of rubber or flexible foam.

7. The one-piece EAS tag of claim 5 wherein the flexible cushion pads may be sized for the one-piece EAS tag to receive different size articles.

8. A one-piece electronic article surveillance (“EAS”) tag comprising a housing having an upper arm and a lower arm, the housing includes an EAS ferrite and/or an RFID label, the upper arm including a spring-loaded telescopic actuator and a pin, the lower arm including a locking mechanism for receiving and locking the pin, an opening between the upper arm and the lower arm for receiving an article through which the pin traverses to hold the article, wherein the improvement comprises having a flexible upper arm.

9. The one-piece EAS tag of claim 8 wherein the upper arm includes a first receiving area for receiving the article and the lower arm includes a second receiving area for receiving the article, wherein the first and second receiving areas are configured to engage the article such that the pin is not exposed.

10. The one-piece EAS tag of claim 9 wherein the first and second receiving areas include flexible cushion pads.

11. The one-piece EAS tag of claim 10 wherein the flexible cushion pads are made of rubber or flexible foam.

12. The one-piece EAS tag of claim 10 wherein the flexible cushion pads may be sized for the one-piece EAS tag to receive different size articles.
